(19) United States
(12) Patent Application Publication
(10) Pub. No.: US 2015/0310478 A1
(43) Pub. Date: Oct. 29, 2015

(54) METHOD AND SYSTEM FOR COMBINING INCENTIVE BUSINESS RULES WITH ADVERTISING MEDIA

(71) Applicant: Outsite Networks, Inc., Norfolk, VA (US)

(72) Inventor: Anton Bakker, Norfolk, VA (US)

(21) Appl. No.: 14/691,967

(22) Filed: Apr. 21, 2015

Related U.S. Application Data
(60) Provisional application No. 61/984,508, filed on Apr. 25, 2014.

(51) Int. Cl. G06Q 30/02

(52) U.S. Cl. CPC G06Q 30/0238; G06Q 30/0222; G06Q 30/0241

(57) ABSTRACT

A system, method, and computer program for combining incentive rules with advertising media, including a mobile phone including an application for accessing a file having media combined with incentive rules. The application playing the media, and including a media decoder to extract and decode the embedded incentive rules from the file, and storing the extracted incentive rules on a storage device of the phone. The application determining a commerce transaction with a point of sale (POS) device and communicating with the POS device to obtain information regarding the commerce transaction. The application determining if based on the stored incentive rules and the obtained information regarding the commerce transaction whether or not a discount or incentive can be issued. If the discount or incentive can be issued, the application communicating with the POS device to issue a corresponding discount or incentive.

### CROSS REFERENCE TO RELATED DOCUMENTS

The present invention claims benefit of priority to U.S. Provisional Patent Application Ser. No. 61/984,508 of Anton BAKKER, entitled “METHOD AND SYSTEM FOR COMBINING INCENTIVE BUSINESS RULES WITH ADVERTISING MEDIA,” filed on Apr. 25, 2014, the entire disclosure of which is hereby incorporated by reference herein.

### BACKGROUND OF THE INVENTION

1. Field of the Invention

The present invention generally relates to systems and methods for promotions processing, and more particular a system and method for combining incentive rules with advertising media for offering, claiming, and redeeming of purchasing incentives, and the like.

2. Discussion of the Background

In recent years, systems and methods for promotions processing have been developed. However, such promotions processing systems and methods lack robustness with respect to digital coupons, applications, user devices, and the like, employed.

### SUMMARY OF THE INVENTION

Therefore there is a need to improve systems and methods for promotions processing with respect to digital coupons, applications, user devices, and the like, employed.

Accordingly, there is provided an improved system, method, and computer program for combining incentive rules with advertising media, including a mobile phone including an application for accessing a file having media combined with incentive rules. The application playing the media, and including a media decoder to extract and decode the embedded incentive rules from the file, and storing the extracted incentive rules on a storage device of the phone. The application determining a commerce transaction with a point of sale (POS) device and communicating with the POS device to obtain information regarding the commerce transaction. The application determining if based on the stored incentive rules and the obtained information regarding the commerce transaction whether or not a discount or incentive can be issued. If the discount or incentive can be issued, the application communicating with the POS device to issue a corresponding discount or incentive.

The application includes a web browser or web browser functionality.

The application communicates with the POS device using a communications mechanism including Bluetooth Low Energy device (BLE).

Information regarding the discount or incentive can be distributed and accessed without employing a third-party couponing and/or discount ecosystem.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary picture of combining a standard media file with incentive/business rules;

FIG. 2 illustrates an exemplary action of an entity offering (directly or indirectly through social sharing or other mechanisms) the incentive by posting the combined media/file to a standard media outlet (e.g., web pages, YouTube, etc.);

FIG. 3 illustrates an exemplary flowchart showing how the embedded rules might culminate in the redemption of an incentive;

FIG. 4 illustrates an exemplary graphic showing a real-world example of embedding data in a media file; and

FIG. 5 illustrates an exemplary system wherein a customer obtains and redeems an incentive discount.

### DETAILED DESCRIPTION OF THE PREFERRED EMBODIMENTS

The present invention includes recognition that manufacturers and retailers like to offer incentives and coupons to their customers, but doing so can be an expensive process. Most traditional methods of distributing coupons and incentives involve a “push” concept, such as mailers (e.g., traditional and electronic), newspaper advertisements and other print media, and the like. Not only is this potentially expensive, as the redemption rate has been shown to be very low, but customers often perceive such “pushes” as intrusive and spam-like. With the emergence of smart-phones and other personal always-online devices, a newer “pull” concept has emerged where the consumer can search for specific offers. While better, this still suffers from market fragmentation, as digital distribution often requires a mating between a customer application and some back-end system operated by the application owners, effectively creating a specific ecosystem. This either limits the audience for the incentive to those using the appropriate application for the appropriate ecosystem, or makes the incentive more expensive for the issuer, as it needs to be issued through multiple ecosystems. Additionally, typical digital coupons are often simply images of their printed counterparts, requiring the scanning of a barcode or the manual entry of some incentive identification (ID). As such, every customer taking advantage of the coupon receives the exact same incentive, significantly limiting targeting and one-to-one communication.

Accordingly, the present disclosure includes a system and method for providing visibility to as many consumers as possible, eliminating the necessity for using a specific ecosystem, enhancing one-to-one targeting and communications, and the like. The system and method allow coupon issuers the ability to embed incentive offers, including a rich set of targeting rules, into common media formats, and the like. For example, a customer can automatically be eligible to receive such incentives simply by viewing the media with the embedded rules. A modified media decoder can be employed to extract the embedded rules and apply them as necessary. Such a modified media decoder can be added to any number of other applications to allow incentives to automatically be applied to any number of electronic store fronts or any suitable retail equipment with which the device is able to communicate (e.g., injecting discount barcodes into a retail Point of Sale system, etc.).

Ecosystems, in general, are eliminated as a user is able to embed rules into advertising media (e.g., graphics, videos, etc.), and customer reach can be expanded as this media can be made available in an almost unlimited set of venues (e.g., web browser pages, YouTube videos, etc.). Such embedded rules take advantage of information known to an application including the modified decoder. Such rules allow the incentive to be controlled and modified, for example, based the customer's demographic information (e.g., gender, age), physical location, purchase history, date and time, current transaction shopping basket, and the like.

Embedding the rules into the media files can be done through a variety of mechanisms, for example, including:

(1) Exchangeable image file format (Exif)—Most commonly used in storing photographic meta-data, Exif information allows for metadata tags to be inserted into various types of image files, most notably JPEG and TIFF.

(2) Extensible Metadata Platform (XMP)—A specification which not only provides a standardized data model and method for serializing such data, but also provides guidelines on how to embed information, such that decoders that are unaware of XMP can still properly process the media file. Advantageously, for example, this allows a single video to be distributed, and which can be understood by the modified decoder, but still be useful as a standard advertising tool to normal media decoders, and the like. Embedded rules can be optionally encrypted to make it difficult, if not impossible, for someone to modify the embedded rules in the media file and redeploy it.

(3) Associated URL as provided by standard web-based HTML linking, where the

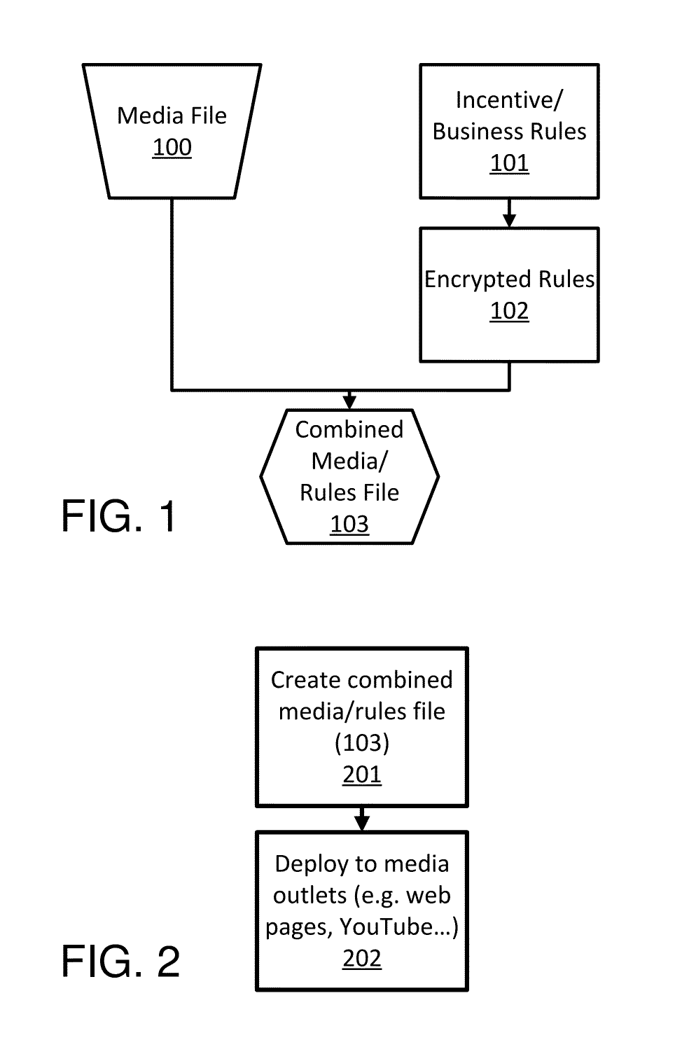

Referring now to the drawings and more particularly to FIG. 1 thereof, there is illustrated generation of a combined media rules file [103]. In FIG. 1, the incentive rules [101], describe the details of the incentive (e.g., purchase requirements, demographic requirements, time of day requirements, etc.) and are encrypted for security purposes into a set of encrypted rules [102] and then merged into a standard media file [101] (e.g., Windows Media Video, MP4, AVI, etc.) using technologies (e.g., Exif, XMP, URL linking, etc.). The resulting combined media/rules file [103] can play normally in any suitable media player able to play the original media file.

In FIG. 2, there is illustrated the placement of the combined media/rules file [103] on a media outlet, such as a company web page, Google advertising, YouTube, and the like. The media/rules file is initially created (as in FIG. 1) as step [201] and can be deployed in step [202] by the original creator or subsequently shared by other users, and the like, as needed. Accordingly, as the media/rules file travels, the embedded rules travel with the media/rules file.

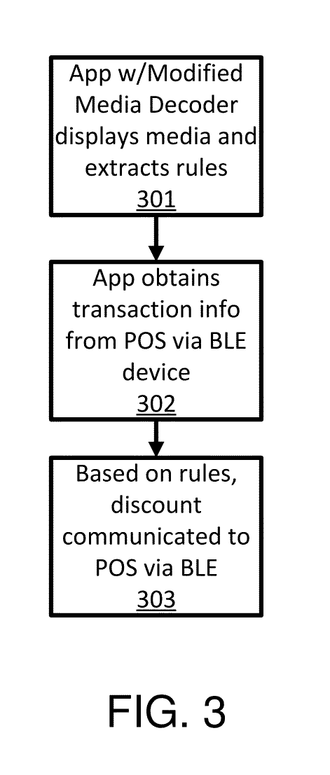

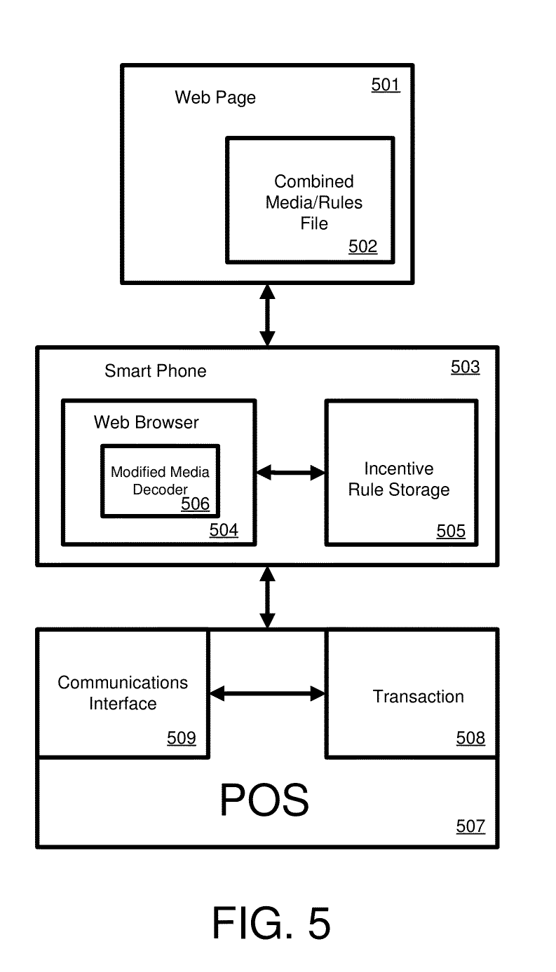

In FIGS. 3 and 5, there is illustrated the flow of how the embedded rules can be used to issue/redeem an incentive. In step [301] an application [504], such as a web browser or custom application incorporating web browser functionality, and the like, that is running on a customer's smart phone [503] accesses, and optionally displays, the combined media/rules file [502] from the web page [501]. The application [504], in addition to, or in lieu of, playing the media file, uses a modified media decoder [506] to extract and decode the encrypted rules [102] from the media file [502], saving it on the smart phone [503] in an area for incentive rules storage [505] for later reference. Step [302] activates when the smart phone application [504] determines that the customer is in a transaction, it can communicate with the Point of Sale (POS) device [507], for example, via a Bluetooth Low Energy device (BLE) or some other suitable communications mechanism [509], and the like, to obtain the contents of the transaction [508]. In step [303], the application [504] can then determine if, based on the stored rules in the incentive rule storage [505] obtained from the media/rules file [502], whether or not a discount or incentive can be issued. If a discount or incentive can be issued, the application communicates with the Point of Sale register to issue that discount or incentive, and the like.

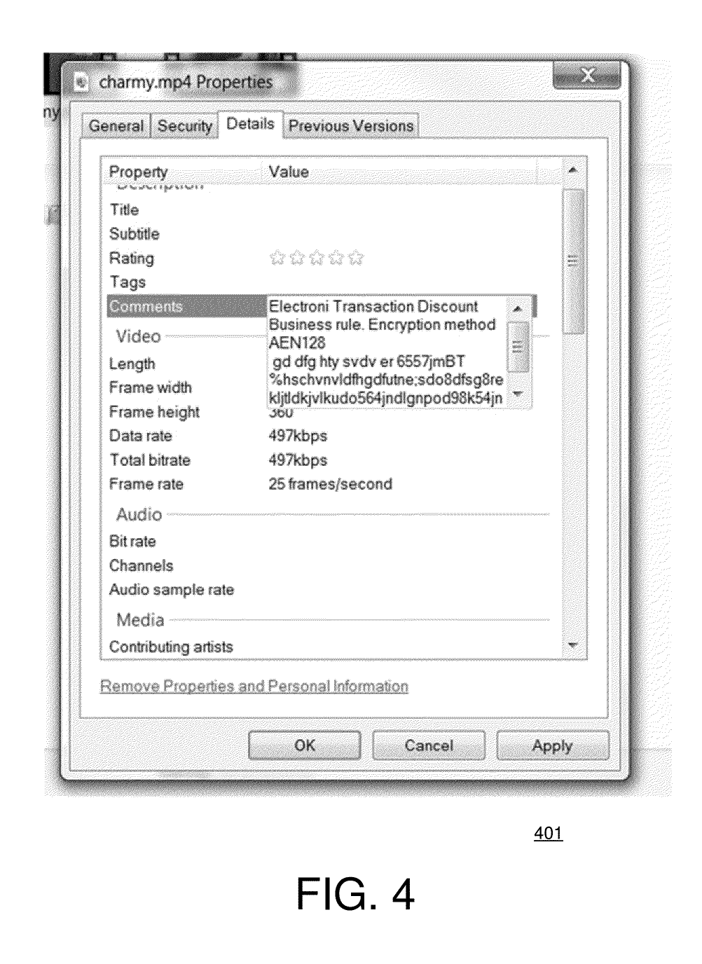

In FIG. 4, there is illustrated, in image [401], an innovative way to embed rules information in a media file, for example, on a Microsoft Window-based machine, and the like. The “comments” field can be used to store satiable information related to the embedded rules information, and the like.

In further exemplary embodiments, data embedded in the media/rules file [103] can include an indirect reference to the corresponding incentive rules, for example, including a suitable identifier, such as a universal resource locator (URL), and the like, which allows the modified media decoder [506] or supplemental application/code to obtain the set of rules. For media where embedding is not necessarily possible or desired, a less efficient method of including the rules at the same location as the media, either directly or indirectly (e.g., via an identifier or URL), can be used. For example, hidden fields on a web page can be configured to include the employed references to the incentive rules, and the like.

The above-described devices and subsystems of the illustrative embodiments of FIGS. 1-5 can include, for example, any suitable servers, workstations, PCs, laptop computers, PDAs, Internet appliances, handheld devices, cellular telephones, wireless devices, other devices, and the like, capable of performing the processes of the illustrative embodiments of FIGS. 1-5. The devices and subsystems of the illustrative embodiments of FIGS. 1-5 can communicate with each other using any suitable protocol and can be implemented using one or more programmed computer systems or devices.

One or more interface mechanisms can be used with the illustrative embodiments of FIGS. 1-5, including, for example, Internet access, telecommunications in any suitable form (e.g., voice, modem, etc.), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like. Accordingly, the devices and subsystems of the illustrative embodiments can be implemented on the World Wide Web.

It is to be understood that the devices and subsystems of the illustrative embodiments of FIGS. 1-5 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-5 can be implemented via one or more programmed computer systems or devices.

To implement such variations as well as other variations, a single computer system can be programmed to perform the special purpose functions of one or more of the devices and subsystems of the illustrative embodiments of FIGS. 1-5. On the other hand, two or more programmed computer systems or devices can be substituted for any one of the devices and subsystems of the illustrative embodiments of FIGS. 1-5. Accordingly, principles and advantages of distributed processing, such as redundancy, replication, and the like, also can be implemented, as desired, to increase the robustness and performance the devices and subsystems of the illustrative embodiments of FIGS. 1-5.

The devices and subsystems of the illustrative embodiments of FIGS. 1-5 can store information relating to various processes described herein. This information can be stored in one or more memories, such as a hard disk, optical disk, magneto-optical disk, RAM, and the like, of the devices and subsystems of the illustrative embodiments of FIGS. 1-5. One or more databases of the devices and subsystems of the illustrative embodiments of FIGS. 1-5 can store the information used to implement the illustrative embodiments of the present invention. The databases can be organized using data structures (e.g., records, tables, arrays, fields, graphs, trees, lists, etc.) included in one or more memories or storage devices listed herein. The processes described with respect to the illustrative embodiments of FIGS. 1-5 can include appropriate data structures for storing data collected and/or generated by the processes of the devices and subsystems of the illustrative embodiments of FIGS. 1-5 in one or more databases thereof.

All or a portion of the devices and subsystems of the illustrative embodiments of FIGS. 1-5 can be conveniently implemented using one or more general purpose computer systems, microprocessors, digital signal processors, micro-controllers, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-5 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-5, for driving the devices and subsystems of the illustrative embodiments of FIGS. 1-5, for enabling the devices and subsystems of the illustrative embodiments of FIGS. 1-5 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-5. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-5 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

What is claimed is:

1. A computer implemented system for combining incentive rules with advertising media, the system comprising:
a mobile phone including an application configured for accessing a file having media combined with incentive rules;
the application configured for playing the media, and including a media decoder configured to extract and decode the embedded incentive rules from the file, and for storing the extracted incentive rules on a storage device of the phone;
the application configured for determining a commerce transaction with a point of sale (POS) device and for communicating with the POS device to obtain information regarding the commerce transaction;
the application configured for determining if based on the stored incentive rules and the obtained information regarding the commerce transaction whether or not a discount or incentive can be issued; and
if the discount or incentive can be issued, the application configured for communicating with the POS device to issue a corresponding discount or incentive.

2. The system of claim 1, wherein the application includes a web browser or web browser functionality.

3. The system of claim 1, wherein the application communicates with the POS device using a communications mechanism including Bluetooth Low Energy device (BLE).

4. The system of claim 1, wherein the system is configured to allow information regarding the discount or incentive to be distributed and accessed without employing a third-party couponing and/or discount ecosystem.

5. A computer implemented method for combining incentive rules with advertising media, the method comprising:
accessing a file having media combined with incentive rules with an application on a mobile phone;
playing with the application the media, including with a media decoder extracting and decoding the embedded incentive rules from the file, and storing the extracted incentive rules on a storage device of the phone;
determining with the application a commerce transaction with a point of sale (POS) device and communicating with the POS device to obtain information regarding the commerce transaction;
determining with the application if based on the stored incentive rules and the obtained information regarding the commerce transaction whether or not a discount or incentive can be issued; and
if the discount or incentive can be issued, communicating with the POS device with the application to issue a corresponding discount or incentive.

6. The method of claim 5, wherein the application includes a web browser or web browser functionality.

7. The method of claim 5, wherein the application communicates with the POS device using a communications mechanism including Bluetooth Low Energy device (BLE).

8. The method of claim 5, wherein the method allows information regarding the discount or incentive to be distributed and accessed without employing a third-party couponing and/or discount ecosystem.

9. A computer program product for combining incentive rules with advertising media and including one or more computer readable instructions embedded on a tangible, non-transitory computer readable medium and configured to cause one or more computer processors to perform the steps of:
accessing a file having media combined with incentive rules with an application on a mobile phone;
playing with the application the media, including with a media decoder extracting and decoding the embedded incentive rules from the file, and storing the extracted incentive rules on a storage device of the phone;
determining with the application a commerce transaction with a point of sale (POS) device and communicating with the POS device to obtain information regarding the commerce transaction;
determining with the application if based on the stored incentive rules and the obtained information regarding the commerce transaction whether or not a discount or incentive can be issued; and
if the discount or incentive can be issued, communicating with the POS device with the application to issue a corresponding discount or incentive.

10. The computer program product of claim 9, wherein the application includes a web browser or web browser functionality.

11. The computer program product of claim 9, wherein the application communicates with the POS device using a communications mechanism including Bluetooth Low Energy device (BLE).

12. The computer program product of claim 9, wherein the method allows information regarding the discount or incentive to be distributed and accessed without employing a third-party couponing and/or discount ecosystem.
